(19) United States
(12) Patent Application Publication
(10) Pub. No.: US 2015/0294393 A1
(43) Pub. Date: Oct. 15, 2015

(54) GOODS INFORMATION PROVIDING SYSTEM, GOODS INFORMATION PROVIDING DEVICE, GOODS INFORMATION PROVIDING METHOD, PROGRAM, AND STORAGE MEDIUM

(71) Applicant: RAKUTEN, INC., Tokyo (JP)

(72) Inventor: Yumie Aikawa, Tokyo (JP)

(73) Assignee: Rakuten, Inc., Tokyo (JP)

(21) Appl. No.: 14/434,113

(22) PCT Filed: Jul. 24, 2013
(86) PCT No.: PCT/JP2013/070049

§ 371 Date: Apr. 8, 2015

(51) Int. Cl. G06Q 30/06

(52) U.S. Cl. CPC G06Q 30/0633

(57) ABSTRACT

A goods information providing system includes: expiration date obtaining means for obtaining, from storage means where information on an item for sale and a displayed expiration date of the item are stored in association with each other, for each item ordered by a user, the displayed expiration date that is associated with the ordered item; and display means for displaying, on a user terminal, pieces of information on the ordered items in chronological order of the displayed expiration dates that have been obtained by the expiration date obtaining means.

### TECHNICAL FIELD

The present invention relates to a goods information providing system, a goods information providing device, a goods information providing method, a program, and a storage medium.

### BACKGROUND ART

Delivery services which allow a user operating a user terminal to order a desired article of food via a Web page and have the food delivered to the user's home have become popular in recent years. The delivered food has a best-before date or a use-by date displayed thereon, and the user consumes the food around the time frame displayed (displayed expiration date). However, once putting the food in a refrigerator or the like, the user may forget to consume the stored food and may not remember until after the displayed expiration date of the food expires.

In Patent Literature 1, there is described a meal menu supplying system which determines whether or not a food item constituting a meal menu and delivered from a delivery center is within its best-before date and, in the case where the best-before date has expired, notifies the user of the expiration of the best-before date.

### CITATION LIST

### Patent Literature

[PTL 1] JP 2006-209382 A

### SUMMARY OF INVENTION

### Technical Problem

With existing technologies, however, it is difficult for a user to keep track of the order in which the displayed expiration dates of a large number of articles of food arrive and consume each article of food by its displayed expiration date.

The present invention has been made in view of the problem described above, and an object of the present invention is to provide a goods information providing system, a goods information providing device, a goods information providing method, a program, and a storage medium with which a user can easily keep track of the order in which the displayed expiration dates of articles of food arrive.

### Solution to Problem

In order to solve the problem described above, a goods information providing system according to one embodiment of the present invention includes: expiration date obtaining means for obtaining, from storage means where information on an item for sale and a displayed expiration date of the item are stored in association with each other, for each item ordered by a user, the displayed expiration date that is associated with the ordered item; and display means for displaying, on a user terminal, pieces of information on the ordered items in chronological order of the displayed expiration dates that have been obtained by the expiration date obtaining means. Note that, the displayed expiration date is a best-before date or a use-by date of the item.

Further, the display means displays, for each of the ordered items, the information on the ordered item in a date cell of a calendar that corresponds to the displayed expiration date of the ordered item.

Further, the information on the ordered item that is displayed in the date cell of the calendar includes a name of the ordered item and a method of treating the ordered item.

Further, the goods information providing system further includes extended amount obtaining means for obtaining, from storage means that stores, for each of the ordered items, a method of treating the ordered item in association with a count of days by which the displayed expiration date of the ordered item is extended, the extended day count that is associated with the treatment method chosen by the user, and, based on the extended day count obtained by the extended amount obtaining means, the displayed expiration date of the ordered item is extended.

Further, the display means displays, for each of the ordered items, the information on the ordered item in a date cell of a calendar that corresponds to the displayed expiration date of the ordered item, and moves the information on the ordered item that has been displayed in the date cell of the calendar to a date cell of the calendar that corresponds to the extended displayed expiration date.

Further, the goods information providing system further includes reception means for receiving information about one of the ordered items regarding whether or not the ordered item has been consumed.

Further, when the reception means receives information indicating that the ordered item has been consumed, the display means displays a message that prompts a repeat order for the ordered item.

Further, the goods information providing system further includes selection means for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.

Further, a goods information providing device according to one embodiment of the present invention includes: expiration date obtaining means for obtaining, from storage means where information on an item for sale and a displayed expiration date of the item are stored in association with each other, for each item ordered by a user, the displayed expiration date that is associated with the ordered item; and transmission means for transmitting, to a user terminal, pieces of information on the ordered items in chronological order of the displayed expiration dates that have been obtained by the expiration date obtaining means.

Further, a goods information providing method according to one embodiment of the present invention includes: obtaining, from storage means where information on an item for sale and a displayed expiration date of the item are stored in association with each other, for each item ordered by a user, the displayed expiration date that is associated with the ordered item; and displaying, on a user terminal, pieces of information on the ordered items in chronological order of the displayed expiration dates that have been obtained by the expiration date obtaining means.

Further, a program according to one embodiment of the present invention causes a computer to function as: expiration date obtaining means for obtaining, from storage means where information on an item for sale and a displayed expiration date of the item are stored in association with each other, for each item ordered by a user, the displayed expiration date that is associated with the ordered item; and display means for displaying, on a user terminal, pieces of information on the ordered items in chronological order of the displayed expiration dates that have been obtained by the expiration date obtaining means.

Further, a storage medium according to one embodiment of the present invention has stored thereon a program for causing a computer to function as: expiration date obtaining means for obtaining, from storage means where information on an item for sale and a displayed expiration date of the item are stored in association with each other, for each item ordered by a user, the displayed expiration date that is associated with the ordered item; and display means for displaying, on a user terminal, pieces of information on the ordered items in chronological order of the displayed expiration dates that have been obtained by the expiration date obtaining means.

### Advantageous Effects of Invention

According to one embodiment of the present invention, information of items ordered by a user are displayed on the user terminal in the chronological order of the displayed expiration dates of the items. The user can thus easily keep track of the order in which the displayed expiration dates of articles of food arrive.

### BRIEF DESCRIPTION OF DRAWINGS

FIG. 1 is a configuration diagram of a goods information providing system according to an embodiment of the present invention.

FIG. 2 is a hardware configuration diagram of a goods information providing device.

FIG. 3 is an example of a food information table.

FIG. 4 is an example of an order information table.

FIG. 5 is an example of a treatment method table.

FIG. 6 is a function block diagram of the goods information providing device.

FIG. 7 is an operation flow chart of the goods information providing device.

FIG. 8A is an example of the order information table.

FIG. 8B is another example of the order information table.

FIG. 9 is a diagram illustrating a display mode of a calendar.

FIG. 10 is another diagram illustrating a display mode of the calendar.

FIG. 11 is an example of a food list.

FIG. 12 is another function block diagram of the goods information providing device.

FIG. 13 is another operation flow chart of the goods information providing device.

FIG. 14 is a diagram illustrating a display mode of the calendar after an update.

FIG. 15 is another diagram illustrating a display mode of the calendar after an update.

FIG. 16 is a diagram illustrating a display mode of the food list after an update.

FIG. 17 is still another function block diagram of the goods information providing device.

FIG. 18 is still another operation flow chart of the goods information providing device.

FIG. 19 is an example of a recipe information table.

### DESCRIPTION OF EMBODIMENTS

An embodiment of the present invention is described below with reference to the drawings.

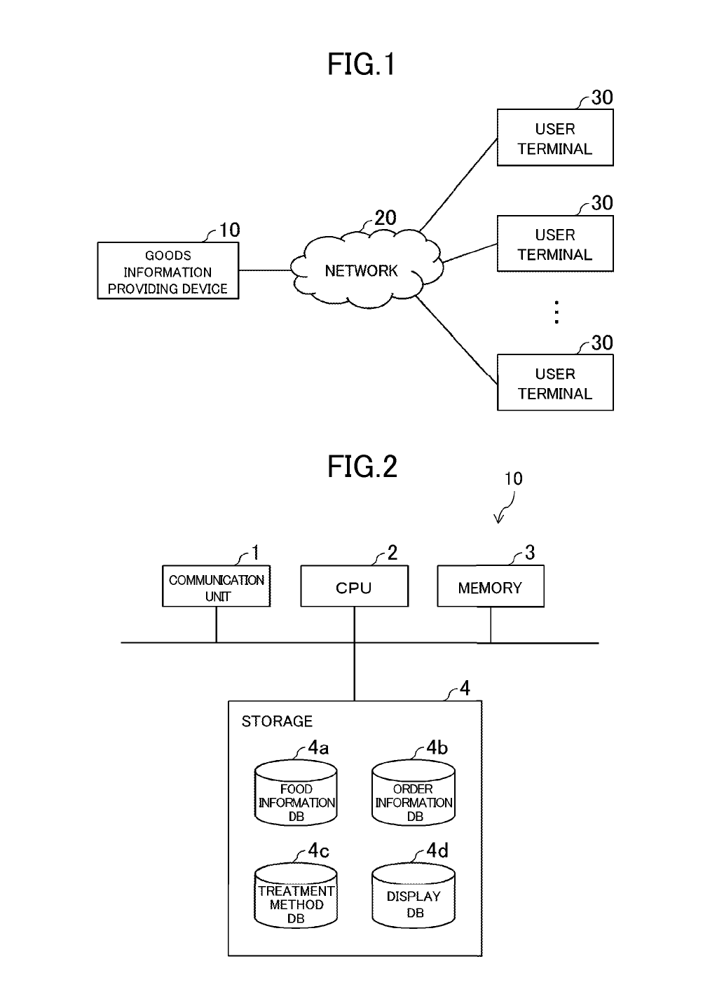

FIG. 1 is a diagram illustrating an example of the schematic configuration of a goods information providing system according to the embodiment of the present invention. As illustrated in FIG. 1, the goods information providing system includes a goods information providing device 10 for providing information on goods (food and the like), and a plurality of user terminals 30 connected to the goods information providing device 10 via a communication network 20. The goods information providing device 10 and each user terminal 30 transmit/receive data to/from each other over the communication network 20, which is the Internet or the like.

The goods information providing system is, for example, for displaying on one of the user terminals 30 various types of information (e.g., a food name, the area of production, a maker name, a displayed expiration date (best-before date is hereinafter taken as an example)) about an article of food that is purchased by a user with the use of the user terminal 30 and a food delivery service via the Internet 20. The food delivery service here is, for example, a service in which, when a user using the Internet accesses a dedicated Website and orders (inputs) a desired article of food on a Web page displayed on the user terminal 30, the food is delivered to the user's home. The food delivery service is not limited to the above-mentioned service which uses the Internet, and may be a service of delivering an item that is ordered by a user by phone, a service of delivering an item that is purchased by a user at a real store, or the like. In short, the food delivery service can be any known service mode. The food delivery service may be included in the goods information providing system or may also be built as a system that is separate from the goods information providing system and transmits/receives data to/from the goods information providing system over a network. The following description takes as an example a mode in which the food delivery service is included in the goods information providing system. A description on how a user orders food and how the food is delivered is omitted.

FIG. 2 is a hardware configuration diagram of the goods information providing device 10. As illustrated in FIG. 2, the goods information providing device 10 is a computer that includes a communication unit 1, a CPU 2, a memory 3, and storage 4. These hardware components are connected to one another by a bus in a manner that allows the exchange of data with one another. The communication unit 1 communicates data with the user terminals 30 via the Internet 20, for example. The CPU 2 controls the components of the device and executes various types of information processing. The memory 3 holds various programs and data. A work area of the CPU 2 is also secured in the memory 3. The goods information providing device 10 is, for example, a management server managed by an administrator (a provider of the service).

The storage 4 contains databases such as a food information DB 4a, an order information DB 4b, a treatment method DB 4c, and a display DB 4d.

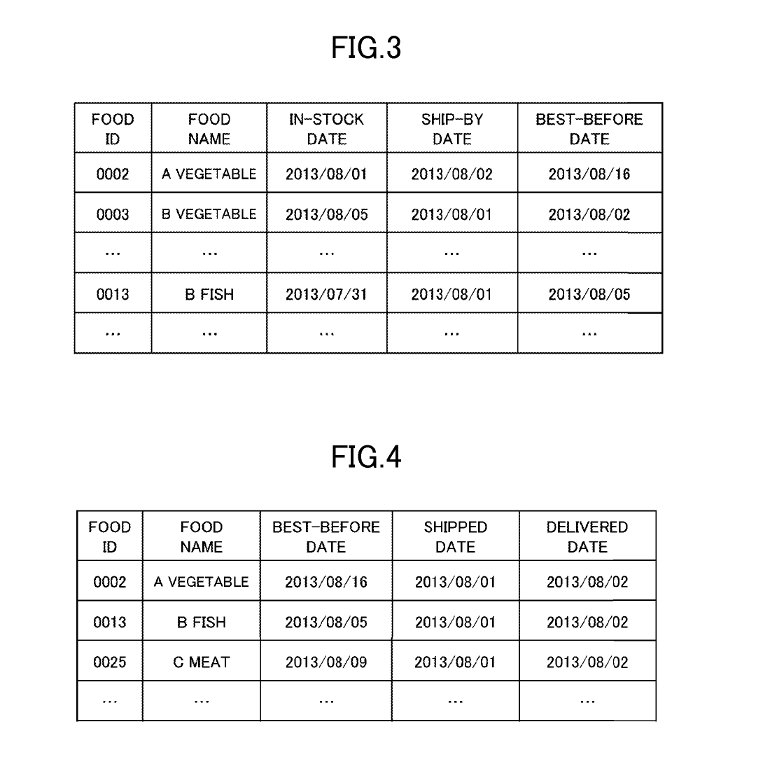

The food information DB 4a stores, in a table, information about a plurality of articles of food carried by the food delivery service. FIG. 3 is an example of a food information table. The food information table includes a food ID, a food name, an in-stock date, a ship-by date, a best-before date, and the like.

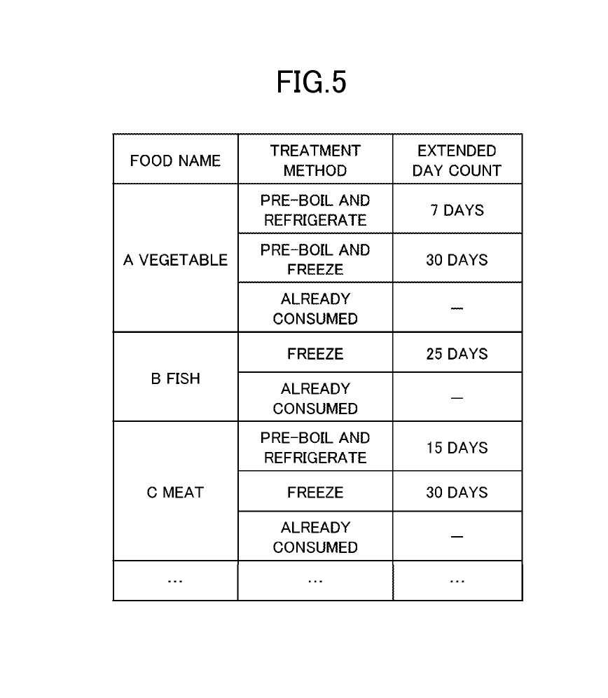

The order information DB 4b stores, in a table prepared for each user, information of food ordered by the user (hereinafter referred to as ordered food). FIG. 4 is an example of an order information table for a user A. The order information table includes a food ID, a food name, a best-before date, a shipped date, a delivered date, and the like.

The treatment method DB 4c stores, in a table, for each article of food registered in the food information table of FIG. 3, a treatment method such as how to store the food and how to prepare the food, and the number of days by which the displayed expiration date can be extended as a result of treating the food by the treatment method. FIG. 5 is an example of a treatment method table. The treatment method table includes “already consumed” as a treatment method to be written in the case where the user has consumed the food. The treatment method and the extended day count are set by the administrator in advance, and are determined in relation to the characteristics of the food. The administrator can also change the treatment method and the extended day count suitably. The treatment method and the extended day count may be set for each article of food, or may be set for each food category (for example, “vegetables”, “fish”, and “meat”).

Each user terminal 30 is a terminal device that can connect to the communication network 20 such as the Internet. A user uses the user terminal 30 for, among others, the purchasing of food through the food delivery service and the receiving of various types of information about ordered food from the goods information providing device 10. For example, the user uses the user terminal 30 to order food on a Web page that is transmitted from the goods information providing device 10, and receives a calendar or a food list in which ordered articles of food are sorted in the order of their best-before dates from the goods information providing device 10. Pieces of software such as a browser and an e-mail client are installed in the user terminal 30. The user terminal 30 can be, for example, a personal computer, a portable information terminal such as a personal digital assistant (PDA) or a smart phone, and a cell phone.

[Providing of Food Information]

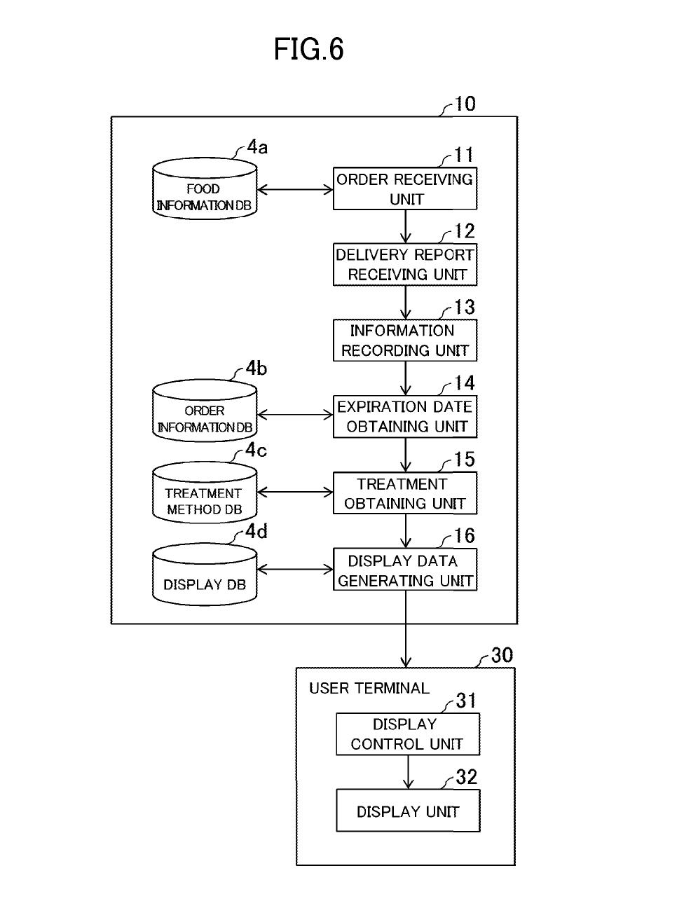

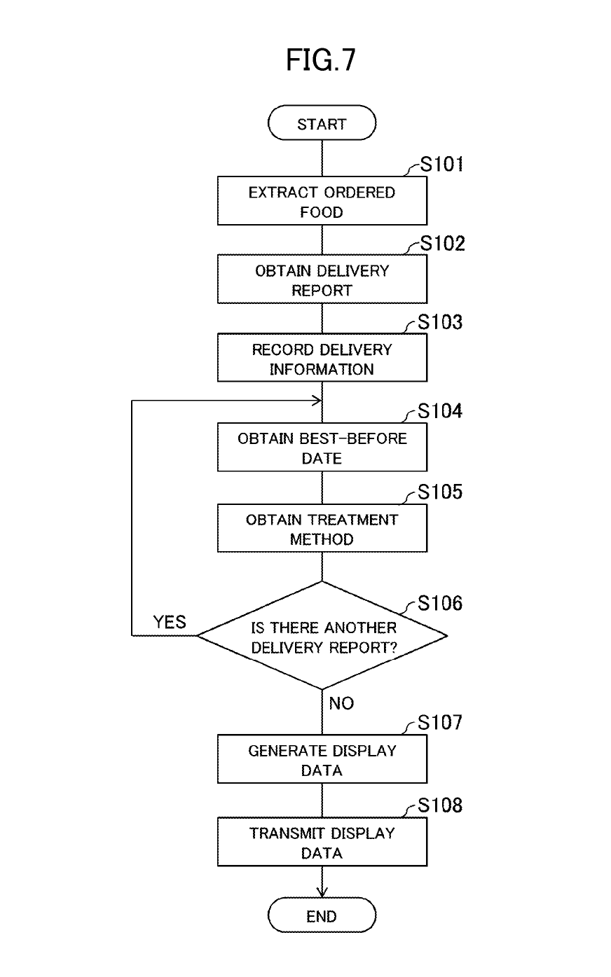

A food information providing method in the goods information providing device 10 is described with reference to FIG. 6 and FIG. 7.

FIG. 6 is a function block diagram of the goods information providing device 10. As illustrated in FIG. 6, the goods information providing device 10 includes, as components for providing food information, an order receiving unit 11, a delivery report receiving unit 12, an information recording unit 13, an expiration date obtaining unit 14 (expiration date obtaining means), a treatment obtaining unit 15 (reception means), and a display data generating unit 16 (transmission means). FIG. 6 illustrates one user terminal 30, which includes a display control unit 31 and a display unit (display means).

FIG. 7 is an operation flow chart of the goods information providing device 10.

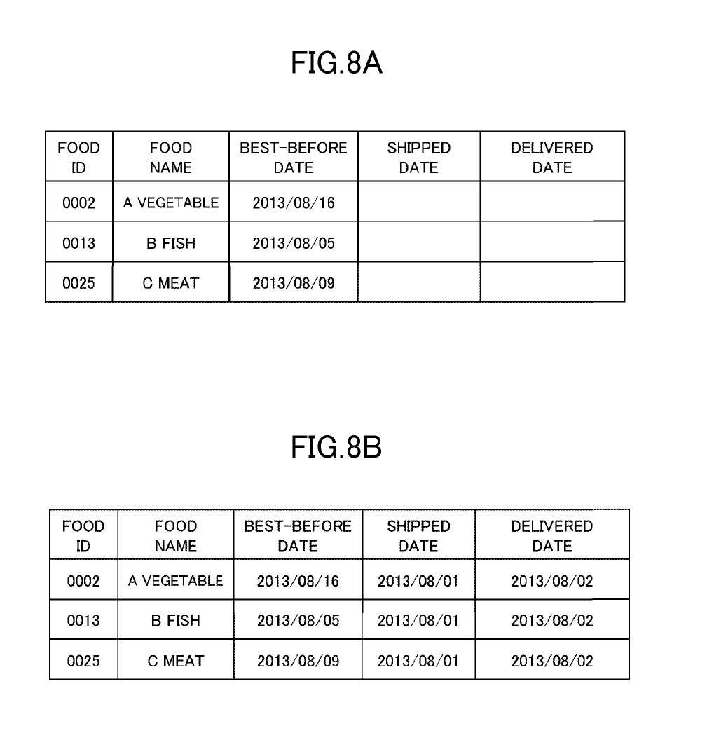

First, the user using the Internet accesses the Website of the food delivery service and orders a desired article of food on a Web page displayed on the user terminal 30. The order receiving unit 11 refers to the food information DB 4a (see FIG. 3) to extract the ordered food (S101). The assumption here is that the user orders an A vegetable, B fish, and C meat. FIG. 8A shows the order information table that has been extracted by the order receiving unit 11.

When the goods information providing device 10 receives an order for food from the user, a person who handles the shipping of goods ships the ordered food, and a person who handles delivery delivers the ordered food to the user's home. When the ordered food has been shipped, the shipped date is recorded in the order information table. The shipped date record may be input manually by the person who handles shipping, or may be input automatically via the scanning of a bar code, which is attached to the food, in a shipping area of a food warehouse. When the ordered food is delivered to the user's home, a report on the completion of delivery is input to the goods information providing device 10. The delivery report may be transmitted by the person who handles delivery with the use of a portable information terminal or the like, or maybe input manually by the person who handles delivery by operating the goods information providing device 10.

The delivery report receiving unit 12 obtains the delivery report (S102), and the information recording unit 13 records delivery information in the order information table (S103). For example, the information recording unit 13 records a delivery completion date in the delivered date field of the order information table. FIG. 8B shows the order information table in which a shipped date and a delivered date have been recorded. Shown in FIG. 8B is a case in which all ordered articles of food are shipped on the same date and delivered on the same date.

When the information recording unit 13 records the delivery information in the order information table, the expiration date obtaining unit 14 refers to the order information DB 4b to obtain, from the order information table (see FIG. 8B), the best-before date of one ordered article of food (S104). For example, the expiration date obtaining unit 14 obtains a best-before date “Aug. 16, 2013” of the A vegetable.

Next, the treatment obtaining unit 15 refers to the treatment method DB 4c to obtain, from the treatment method table (see FIG. 5), a treatment method of one ordered article of food (S105). For example, the treatment obtaining unit 15 obtains treatment methods “pre-boil and refrigerate”, “pre-boil and freeze”, and “already consumed” of the A vegetable.

Next, in the case where there is another ordered article of food for which a delivered date has been recorded in the order information table (see FIG. 8B) (YES in S106), the goods information providing device 10 returns to S104, where the expiration date obtaining unit 14 obtains the best-before date of the other ordered article of food (S104), and then the treatment obtaining unit 15 obtains a treatment method of the other ordered article of food (S105). Here, a best-before date and a treatment method are obtained for each of the B fish and the C meat.

Next, the display data generating unit 16 obtains, from the display DB 4d, for each best-before date obtained above, a monthly calendar that includes the date of the best-before date, and associates an ordered food name and a treatment method with a cell for the date of the best-before date. Treatment methods may be associated in a pull-down format or may be associated so that the treatment methods are displayed in a list format. The display data generating unit 16 generates the associated calendar display data as, for example, an html file (S107).

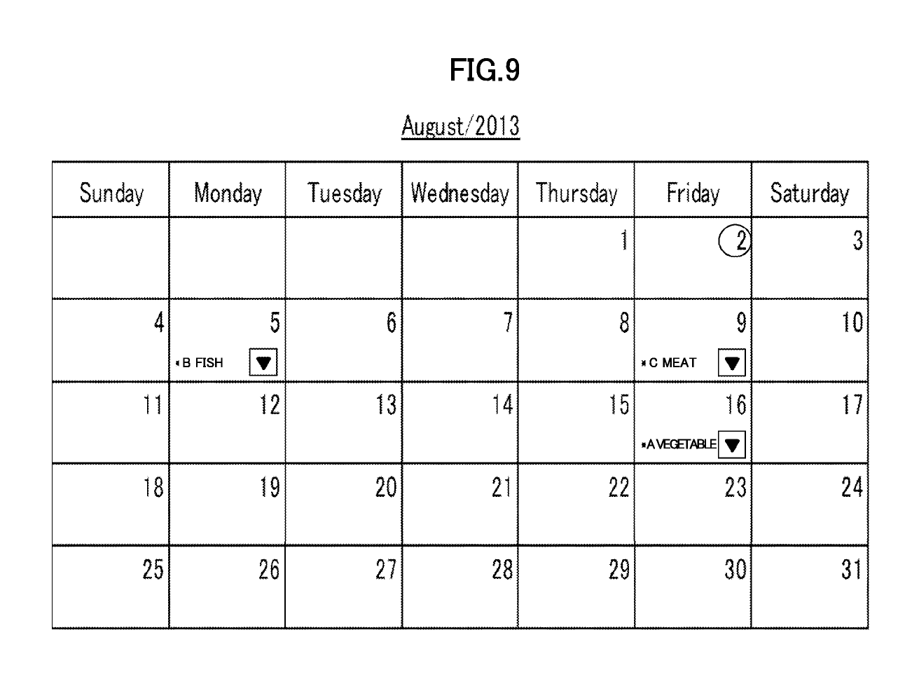

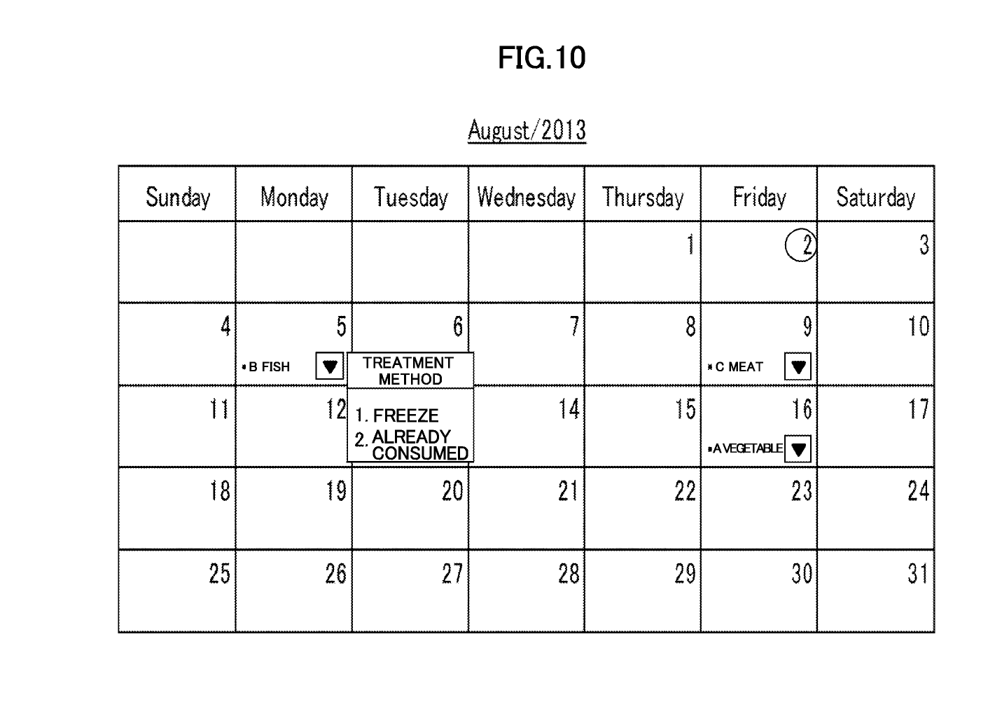

The display data generating unit 16 transmits the generated display data (html file) to the user terminal 30 via the communication unit 1 (S108). The user terminal 30 receives the display data and the display control unit 31 of the user terminal 30 displays the calendar on the display unit 32. FIG. 9 illustrates a mode of the calendar displayed on the display unit 32. The calendar displays, for each ordered article of food, a treatment method in association with a best-before date of the food. For example, as illustrated in FIG. 10, clicking on a pull-down mark for a best-before date “Aug. 5, 2013” of the B fish causes the calendar to display a treatment method menu that includes “freeze” and “already consumed”. As illustrated in FIG. 9 and FIG. 10, the displayed current date (here, “Aug. 2, 2013”) may be highlighted (e.g., circled). The calendar may also display, for each best-before date, the number of days from the current date to the best-before date (the number of days remaining till the best-before date) in the cell for the date of the best-before date.

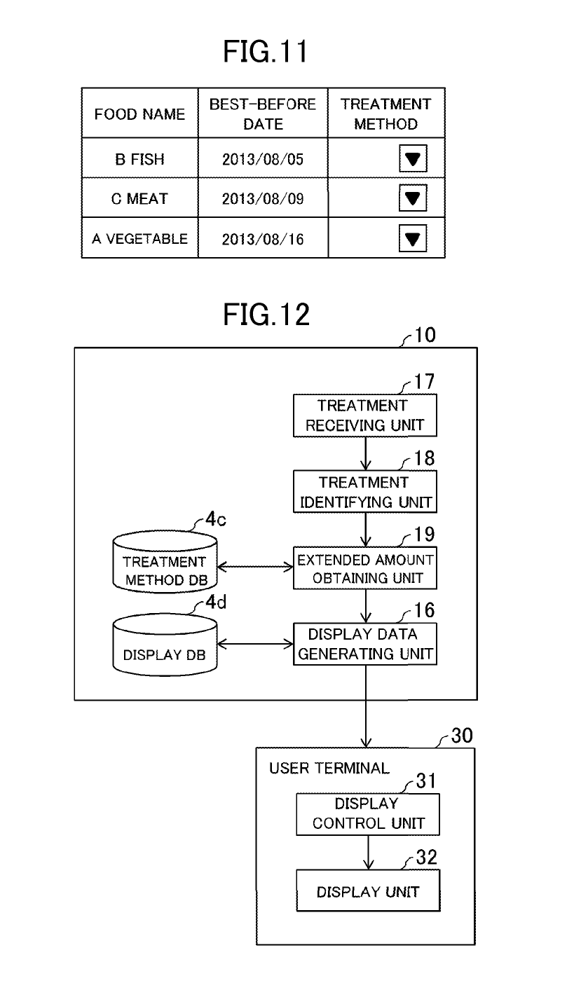

The display data generated by the display data generating unit 16 is not limited to the calendar format and may be in a list format. For example, the display data may be a food list in which ordered articles of food are sorted in the order of their best-before dates as illustrated in FIG. 11. A selection field for a treatment method is provided in the food list. The display data generating unit 16 stores the generated display data in the display DB 4d.

The goods information providing system according to this embodiment enables a user to easily keep track of the order in which the best-before dates of a large number of articles of food arrive.

[Extending of Best-Before Date]

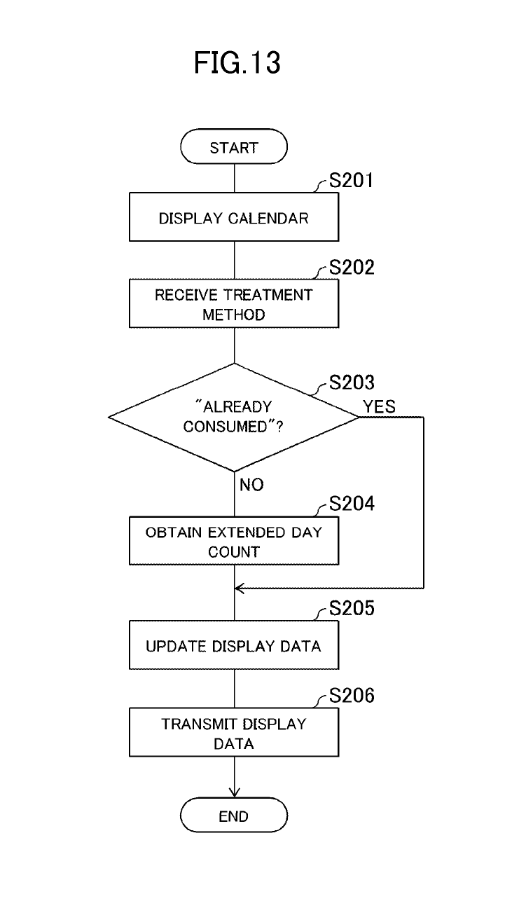

The goods information providing device 10 further has a function of appropriately reflecting a best-before date that has been extended by an amount determined by how a user has treated an article of food in question, and providing information on the order in which extended best-before dates arrive. A best-before date extending method in the goods information providing device 10 is described with reference to FIG. 12 and FIG. 13.

FIG. 12 is another function block diagram of the goods information providing device 10. As illustrated in FIG. 12, the goods information providing device 10 further includes a treatment receiving unit 17, a treatment identifying unit 18, and an extended amount obtaining unit 19 as components for reflecting extended best-before dates. The components illustrated in FIG. 6 are omitted from FIG. 12 as appropriate.

FIG. 13 is another operation flow chart of the goods information providing device 10.

First, display data (for example, an html file corresponding to a calendar) is transmitted from the goods information providing device 10 (S108 of FIG. 7). The user terminal 30 receives the display data and displays the calendar (see FIG. 9) on the display unit (S201).

Next, the user chooses one of food treatment methods displayed in the calendar, and the treatment receiving unit 17 of the goods information providing device 10 receives the treatment method chosen (S202). For example, when the user chooses a treatment method “freeze” of the B fish, the treatment receiving unit 17 receives the treatment method “freeze”.

Next, the treatment identifying unit 18 identifies whether or not the treatment method received by the treatment receiving unit 17 is “already consumed” (S203). The goods information providing device 10 moves to S204 when the treatment method is not “already consumed”, and moves to S205 when the treatment method is “already consumed”.

In the case where the treatment method is not “already consumed”, the extended amount obtaining unit 19 refers to the treatment method table (see FIG. 5) in the treatment method DB 4c to obtain an extended day count that is associated with the method of treating the ordered food chosen by the user. For example, when the user chooses “freeze” for the B fish, the extended amount obtaining unit 19 obtains “25 days” as the extended day count.

Next, the display data generating unit 16 obtains display data that corresponds to a calendar (see FIG. 9) stored in the display DB 4d, adds the extended day count obtained by the extended amount obtaining unit 19 to a best-before date set in advance, and associates an ordered food name and a treatment method with a cell for the date of the extended best-before date (S205). For example, an extended best-before date “Aug. 30, 2013” which is obtained by adding an extended day count “25 days” to a best-before date “Aug. 5, 2013” of the B fish is associated with “B fish” and a treatment method. Only “already consumed” is set as the treatment method associated with the cell for the date of the extended best-before date. The calendar may be set so that the displayed cell for the date of the extended best-before date is highlighted.

When the treatment method is found to be “already consumed” in S203, on the other hand, the display data generating unit 16 obtains display data that corresponds to a calendar (see FIG. 9) stored in the display DB 4d, and deletes an ordered food name and treatment method of the consumed food that are associated with a cell for the date of the best-before date.

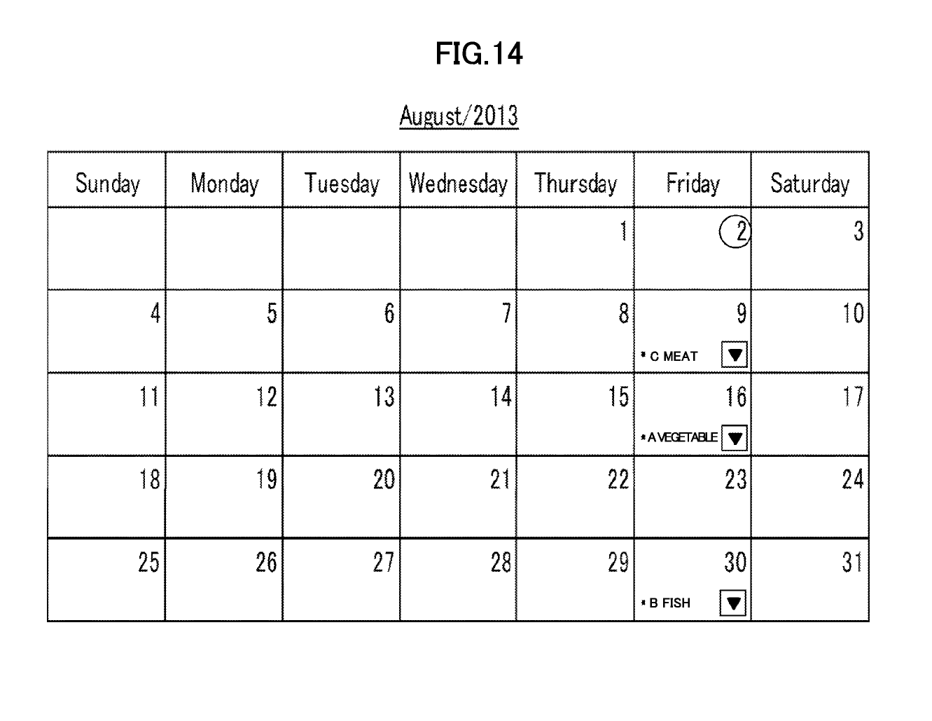

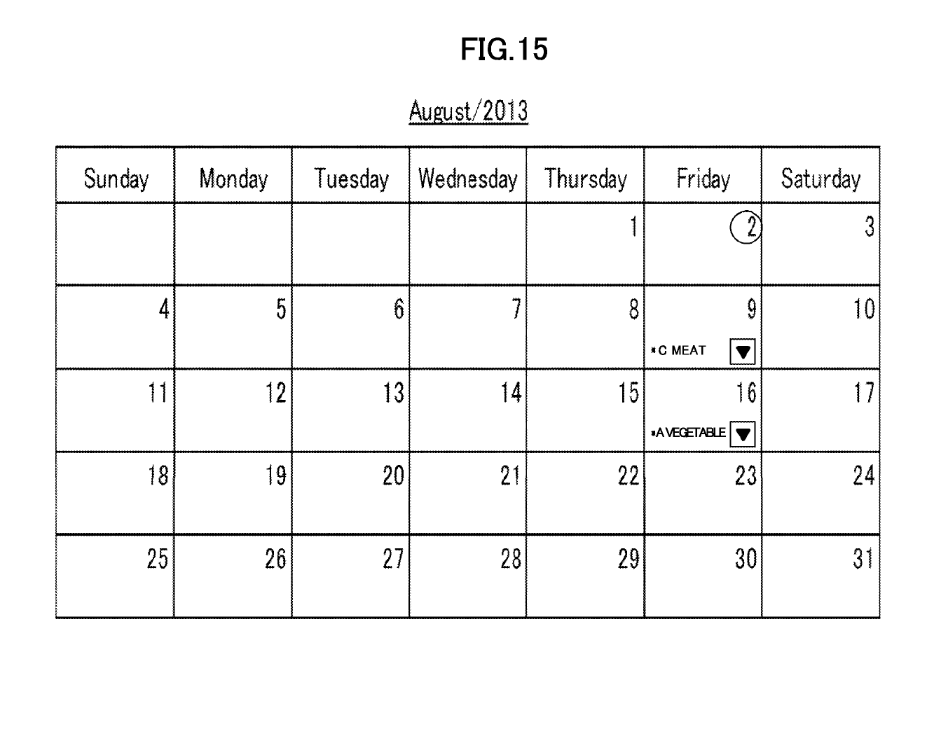

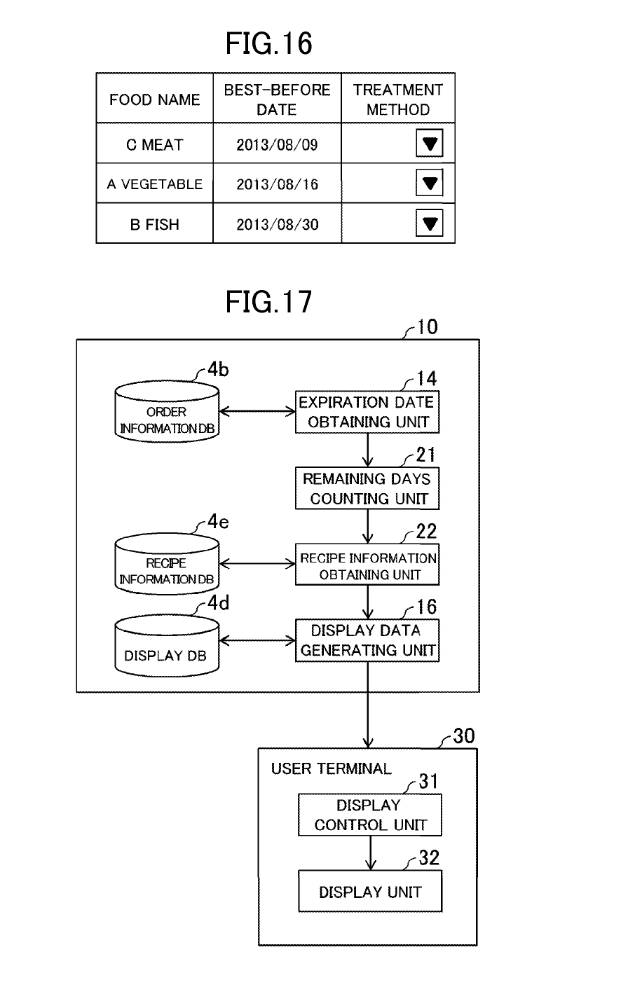

The display data generating unit 16 transmits the updated display data (html file) to the user terminal 30 via the communication unit 1 (S206). The user terminal 30 receives the display data, and displays the updated calendar on the display unit 32 of the user terminal 30. FIG. 14 illustrates a mode of the calendar after an update in which the best-before date of the “B fish” has been extended to “Aug. 30, 2013”. FIG. 15 illustrates a mode of the calendar after an update in which information of the “B fish” has been deleted. FIG. 16 illustrates a mode of the food list after an update in which the best-before date of the “B fish” has been extended to “Aug. 30, 2013”.

The goods information providing system according to this embodiment is capable of extending a best-before date by an amount that is determined in relation to how the food is stored and how the food is prepared, and thus enables a user to easily keep track of the order in which extended best-before dates arrive.

In the case where the user chooses “already consumed” for an article of food, the display data generating unit 16 may transmit to the user terminal 30 a message that prompts the user to order the same food as the consumed food, or related food. The message may be displayed in the updated calendar on the display unit 32 of the user terminal 30, or may be displayed in a separate comment field. The message may also be transmitted to the user terminal 30 in the form of e-mail. This motivates the user to purchase and keeps the user from being out of a necessary article of food.

[Providing of Recipe Information]

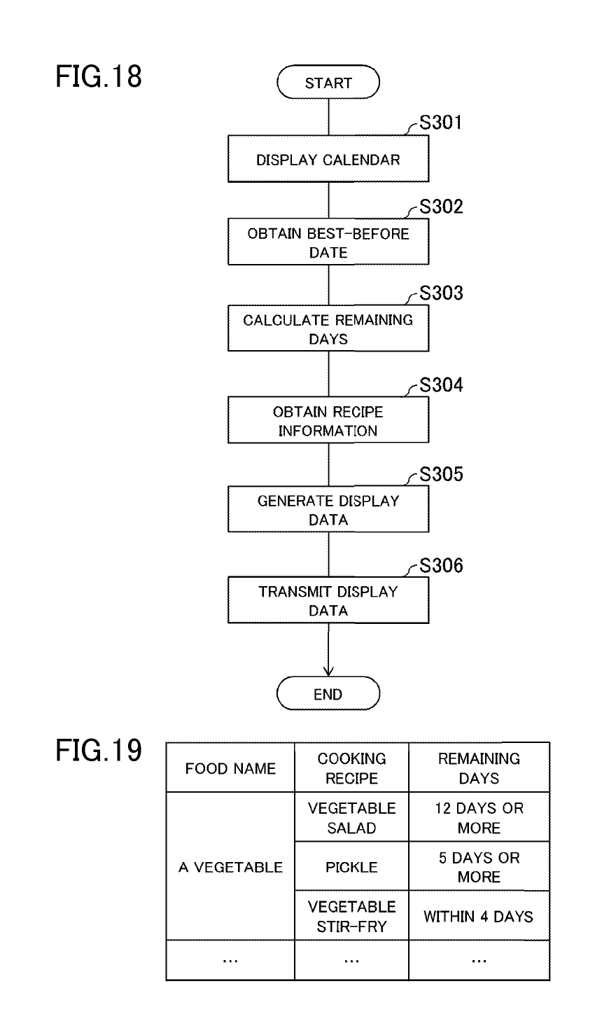

The goods information providing device 10 further has a function of providing information of a cooking recipe that uses an article of food (a food item) in relation to the best-before date of the food. A cooking recipe information providing method in the goods information providing device 10 is described with reference to FIG. 17 and FIG. 18.

FIG. 17 is still another function block diagram of the goods information providing device 10. As illustrated in FIG. 17, the goods information providing device 10 further includes, as components for providing cooking recipe information, a remaining days calculating unit 21 and a recipe information obtaining unit (selection means). The storage 4 further contains a recipe information DB 4e. The components illustrated in FIG. 6 and FIG. 12 are omitted from FIG. 17 as appropriate.

FIG. 18 is still another operation flow chart of the goods information providing device 10.

First, display data (an html file corresponding to a calendar) is transmitted from the goods information providing device 10 (S108 of FIG. 7). The user terminal 30 receives the display data and displays the calendar (see FIG. 9) on the display unit 32 (S301).

Next, the user selects an article of food displayed on the calendar. The expiration date obtaining unit 14 of the goods information providing device 10 refers to the order information DB 4b to obtain, from the order information table (see FIG. 8B), the best-before date of the selected food (S302).

Next, the remaining days calculating unit 21 calculates a difference between the current date and the best-before date of the selected food (the number of days remaining till the best-before date) (S303). For example, in the case where the user selects the “A vegetable” in FIG. 9 (the current date “Aug. 2, 2013”), the remaining days are “14 days”. In the case where the user selects the “A vegetable” when the current date is “Aug. 14, 2013”, the remaining days are “2 days”.

Next, the recipe information obtaining unit 22 refers to the recipe information DB 4e to obtain recipe information that is associated with the remaining days calculated by the remaining days calculating unit 21 (S304).

The recipe information DB 4e is now described. FIG. 19 is an example of a recipe information table which is stored in the recipe information DB 4e. The recipe information table associates an article of food (a food item), a cooking recipe that uses the food item, and the number of days remaining till a best-before date of the food with respect to the cooking recipe with one another. For example, as shown in FIG. 19, cooking recipes “vegetable salad”, “pickle”, and “vegetable stir-fry” are set for the A vegetable, and the numbers of days remaining till the best-before dates of the A vegetable, “12 days or more”, “5 days or more”, and “within 4 days” are set for the respective cooking recipes.

Accordingly, in the case where the user selects the “A vegetable” when the current date is, for example, “Aug. 2, 2013”, the recipe information obtaining unit 22 refers to the recipe information table of FIG. 19 to obtain the recipe information “vegetable salad”, which is a recipe for when there are many days left till the best-before date. In the case where the user selects the “A vegetable” when the current date is, for example, “Aug. 14, 2013”, the recipe information obtaining unit 22 obtains the recipe information “vegetable stir-fry”, which is a recipe for when the best-before date is approaching.

When recipe information is obtained, the display data generating unit 16 generates display data about the recipe information (S305), and transmits the display data to the user terminal (S306). The display data generating unit 16 may generate the display data in association with a calendar, or may generate display data of a recipe page as a separate html file.

The recipe information DB 4e may store, for each food item, a recipe information table for compiling cooking recipes using the food items that are for when there are many days left till the best-before date (for when the number of remaining days is large), and a recipe information table for compiling cooking recipes using the food items that are for when there are few days left till the best-before date (for when the number of remaining days is small).

The goods information providing device 10 may be configured so as to calculate, for each article of food (a food item), the difference between the current date and the best-before date of the food item, select a food item based on the calculated difference, and obtain a cooking recipe that uses the selected food item. For example, the goods information providing device 10 preferentially selects a food item whose best-before date is approaching from the order information table (see FIG. 8B), obtains a cooking recipe that uses the selected food item, and transmits the cooking recipe to the user terminal 30. The goods information providing device 10 may include a function for allowing the user to choose whether to use a food item whose best-before date is far off or a food item whose best-before date is close.

The goods information providing system according to this embodiment is capable of providing a user with information of a cooking recipe that is suitable for the best-before date of a food item.

The functions of the components that are included in the goods information providing device 10 described above are implemented by executing a program that is stored in the memory 3 with the CPU 2. The program may be installed in the goods information providing device 10 from a computer-readable storage medium such as a CD-ROM, a DVD-ROM, or a memory card, or may be downloaded from a communication network such as the Internet.

1. A goods information providing system, comprising:
expiration date obtaining means for obtaining, from storage means where information on an item for sale and a displayed expiration date of the item are stored in association with each other, for each item ordered by a user, the displayed expiration date that is associated with the ordered item;
display means for displaying, on a user terminal, pieces of information on the ordered items in chronological order of the displayed expiration dates that have been obtained by the expiration date obtaining means;
extended amount obtaining means for obtaining, from storage means that stores, for each of the ordered items, a method of treating the ordered item in association with a count of days by which the displayed expiration date of the ordered item is extended, the extended day count that is associated with the treatment method chosen by the user; and
expiration date extending means for extending the displayed expiration date of the ordered item based on the extended day count obtained by the extended amount obtaining means.

2. The goods information providing system according to claim 1, wherein the display means displays, for each of the ordered items, the information on the ordered item in a date cell of a calendar that corresponds to the displayed expiration date of the ordered item.

3. The goods information providing system according to claim 2, wherein the information on the ordered item that is displayed in the date cell of the calendar comprises a name of the ordered item and a method of treating the ordered item.

4. (canceled)

5. The goods information providing system according to claim 1, wherein the display means displays, for each of the ordered items, the information on the ordered item in a date cell of a calendar that corresponds to the displayed expiration date of the ordered item, and moves the information on the ordered item that has been displayed in the date cell of the calendar to a date cell of the calendar that corresponds to the extended displayed expiration date.

6. The goods information providing system according to claim 1, further comprising reception means for receiving information about one of the ordered items regarding whether or not the ordered item has been consumed.

7. The goods information providing system according to claim 6, wherein, when the reception means receives information indicating that the ordered item has been consumed, the display means displays a message that prompts a repeat order for the ordered item.

8. The goods information providing system according to claim 1, further comprising selection means for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.

9. A goods information providing device, comprising:
expiration date obtaining means for obtaining, from storage means where information on an item for sale and a displayed expiration date of the item are stored in association with each other, for each item ordered by a user, the displayed expiration date that is associated with the ordered item;
transmission means for transmitting, to a user terminal, pieces of information on the ordered items that are sorted in chronological order of the displayed expiration dates that have been obtained by the expiration date obtaining means;
extended amount obtaining means for obtaining, from storage means that stores, for each of the ordered items, a method of treating the ordered item in association with a count of days by which the displayed expiration date of the ordered item is extended, the extended day count that is associated with the treatment method chosen by the user; and
expiration date extending means for extending the displayed expiration date of the ordered item based on the extended day count obtained by the extended amount obtaining means.

10. A goods information providing method to be executed by a computer, comprising:
an expiration date obtaining step for obtaining, from storage means where information on an item for sale and a displayed expiration date of the item are stored in association with each other, for each item ordered by a user, the displayed expiration date that is associated with the ordered item;
a transmission step for transmitting, to a user terminal, pieces of information on the ordered items that are sorted in chronological order of the displayed expiration dates that have been obtained at the expiration date obtaining step;
an extended amount obtaining step for obtaining, from storage means that stores, for each of the ordered items, a method of treating the ordered item in association with a count of days by which the displayed expiration date of the ordered item is extended, the extended day count that is associated with the treatment method chosen by the user; and
an expiration date extending step for extending the displayed expiration date of the ordered item based on the extended day count obtained at the extended amount obtaining step.

11. (canceled)

12. A computer-readable storage medium having stored thereon a program for causing a computer to function as:
expiration date obtaining means for obtaining, from storage means where information on an item for sale and a displayed expiration date of the item are stored in association with each other, for each item ordered by a user, the displayed expiration date that is associated with the ordered item;
transmission means for transmitting, to a user terminal, pieces of information on the ordered items that are sorted in chronological order of the displayed expiration dates that have been obtained by the expiration date obtaining means;
extended amount obtaining means for obtaining, from storage means that stores, for each of the ordered items, a method of treating the ordered item in association with a count of days by which the displayed expiration date of the ordered item is extended, the extended day count that is associated with the treatment method chosen by the user; and
expiration date extending means for extending the displayed expiration date of the ordered item based on the extended day count obtained by the extended amount obtaining means.

13. The goods information providing method according to claim 10, further comprising a display step for displaying, on a user terminal, pieces of information on the ordered items in chronological order of the displayed expiration dates that have been obtained at the expiration date obtaining step,
wherein, at the display step, for each of the ordered items, the information on the ordered item is displayed in a date cell of a calendar that corresponds to the displayed expiration date of the ordered item.

14. The goods information providing method according to claim 13, wherein the information on the ordered item that is displayed in the date cell of the calendar comprises a name of the ordered item and a method of treating the ordered item.

15. The goods information providing method according to claim 10, further comprising a display step for displaying, on a user terminal, pieces of information on the ordered items in chronological order of the displayed expiration dates that have been obtained at the expiration date obtaining step,
Wherein, at the display step, for each of the ordered items, the information on the ordered item is displayed in a date cell of a calendar that corresponds to the displayed expiration date of the ordered item, and the information on the ordered item that has been displayed in the date cell of the calendar is moved to a date cell of the calendar that corresponds to the extended displayed expiration date.

16. The goods information providing method according to claim 10, further comprising a reception step for receiving information about one of the ordered items regarding whether or not the ordered item has been consumed.

17. The goods information providing method according to claim 16, wherein, when information indicating that the ordered item has been consumed is received at the reception step, a message that prompts a repeat order for the ordered item is displayed at the display step.

18. The goods information providing method according to claim 10, further comprising a selection step for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.

19. A goods information providing system, comprising:
expiration date obtaining means for obtaining, from storage means where information on an item for sale and a displayed expiration date of the item are stored in association with each other, for each item ordered by a user, the displayed expiration date that is associated with the ordered item;
display means for displaying, on a user terminal, pieces of information on the ordered items in chronological order of the displayed expiration dates that have been obtained by the expiration date obtaining means; and
selection means for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.

20. The goods information providing system according to claim 19, wherein the display means displays, for each of the ordered items, the information on the ordered item in a date cell of a calendar that corresponds to the displayed expiration date of the ordered item.

21. The goods information providing system according to claim 20, wherein the information on the ordered item that is displayed in the date cell of the calendar comprises a name of the ordered item and a method of treating the ordered item.

22. The goods information providing system according to claim 19, wherein the display means displays, for each of the ordered items, the information on the ordered item in a date cell of a calendar that corresponds to the displayed expiration date of the ordered item, and moves the information on the ordered item that has been displayed in the date cell of the calendar to a date cell of the calendar that corresponds to the extended displayed expiration date.

23. The goods information providing system according to claim 19, further comprising reception means for receiving information about one of the ordered items regarding whether or not the ordered item has been consumed.

24. The goods information providing system according to claim 23, wherein, when the reception means receives information indicating that the ordered item has been consumed, the display means displays a message that prompts a repeat order for the ordered item.

25. A goods information providing device, comprising:
expiration date obtaining means for obtaining, from storage means where information on an item for sale and a displayed expiration date of the item are stored in association with each other, for each item ordered by a user, the displayed expiration date that is associated with the ordered item;
transmission means for transmitting, to a user terminal, pieces of information on the ordered items that are sorted in chronological order of the displayed expiration dates that have been obtained by the expiration date obtaining means; and
selection means for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.

26. A goods information providing method to be executed by a computer, comprising:
an expiration date obtaining step for obtaining, from storage means where information on an item for sale and a displayed expiration date of the item are stored in association with each other, for each item ordered by a user, the displayed expiration date that is associated with the ordered item;
a transmission step for transmitting, to a user terminal, pieces of information on the ordered items that are sorted in chronological order of the displayed expiration dates that have been obtained at the expiration date obtaining step; and
a selection step for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.

27. The goods information providing method according to claim 26, further comprising a display step for displaying, on a user terminal, pieces of information on the ordered items in chronological order of the displayed expiration dates that have been obtained at the expiration date obtaining step,
Wherein, at the display step, for each of the ordered items, the information on the ordered item is displayed in a date cell of a calendar that corresponds to the displayed expiration date of the ordered item.

28. The goods information providing method according to claim 27, wherein the information on the ordered item that is displayed in the date cell of the calendar comprises a name of the ordered item and a method of treating the ordered item.

29. The goods information providing method according to claim 26, further comprising a display step for displaying, on a user terminal, pieces of information on the ordered items in chronological order of the displayed expiration dates that have been obtained at the expiration date obtaining step,
Wherein, at the display step, for each of the ordered items, the information on the ordered item is displayed in a date cell of a calendar that corresponds to the displayed expiration date of the ordered item, and the information on the ordered item that has been displayed in the date cell of the calendar is moved to a date cell of the calendar that corresponds to the extended displayed expiration date.

30. The goods information providing method according to claim 26, further comprising a reception step for receiving information about one of the ordered items regarding whether or not the ordered item has been consumed.

31. The goods information providing method according to claim 30, wherein, when information indicating that the ordered item has been consumed is received at the reception step, a message that prompts a repeat order for the ordered item is displayed at the display step.

32. A computer-readable storage medium having stored thereon a program for causing a computer to function as:
expiration date obtaining means for obtaining, from storage means where information on an item for sale and a displayed expiration date of the item are stored in association with each other, for each item ordered by a user, the displayed expiration date that is associated with the ordered item;
transmission means for transmitting, to a user terminal, pieces of information on the ordered items that are sorted in chronological order of the displayed expiration dates that have been obtained by the expiration date obtaining means; and
selection means for selecting, from storage means that stores, for each of the ordered items, at least one cooking recipe that uses the ordered item in association with a count of days remaining till the displayed expiration date of the ordered item, the cooking recipe based on a difference between a current date and the displayed expiration date of the ordered item.
